(19) United States
(12) Patent Application Publication
(10) Pub. No.: US 2008/0261142 A1
(43) Pub. Date: Oct. 23, 2008

(54) Toner Powders and Process for Their Preparation

(76) Inventors: Kevin Jeffrey Kittle, Chester-le-Street (GB); Andrew Robert Morgan, Ryton (GB)

Correspondence Address: KENYON & KENYON LLP, ONE BROADWAY, NEW YORK, NY, 10004, US

(21) Appl. No.: 11/995,520

(22) PCT Filed: Jul. 11, 2006
(86) PCT No.: PCT/EP06/64089

§ 371 Date: Jul. 3, 2008

(30) Foreign Application Priority Data
Jul. 11, 2005 (EP) 05106315.4

(51) Int. Cl. G03G 9/08; G03G 13/16

(52) U.S. Cl. 430/111.4; 430/137.14; 430/105; 430/125.3

(57) ABSTRACT

The present invention pertains to a process for the preparation of a toner powder, in which particles of one or more toner base compositions are combined into larger particles. The toner base compositions may be in the form of dry powders, e.g., manufactured by jet milling or by freeze drying powder dispersions. In that case, the combination of the toner base compositions into larger particles may be done by, e.g., mechanofusion. The toner base composition may also be in the form of an aqueous emulsion or dispersion. In that case, the combination of the base compositions into larger particles can be effected by spray-drying the emulsion or dispersion. In a preferred embodiment, the toner base composition in aqueous form is prepared via phase inversion emulsification, which preferably is carried out in an extruder. The invention also pertains to a toner powder comprising composite particles in which individual particles of toner base composition(s) are fused or bonded together in the form of cluster structures that do not break down under the mechanical and electrostatic forces encountered during toner use. This can be obtained by mechanofusion of dry toner base powders. The invention also pertains to a toner powder comprising composite particles in which individual particles of toner base composition(s) are fused or bonded together to form single substantially spherical particles. This can be obtained by spray drying of an aqueous emulsion or dispersion. The toner powders of the present invention have increased fluidity as compared to conventional powders. Toners with different colours can be prepared in a simple and convenient manner.

### FIELD OF THE INVENTION

The present invention relates to a process for preparing a toner composition for electrographic copying and printing. Such processes are also known as electrophotography, and as electrostatic recording and printing, and also as magnetography and iconography.

Toner compositions (also referred to as powder inks) generally comprise a resin, a colouring agent, optionally a charge-control agent, and optionally a wax, and are generally prepared by intimately mixing the ingredients, for example in an extruder, at a temperature above the softening point of the resin. The extrudate is then milled, for example jet-milled, to produce the toner powder with a relatively fine particle size distribution.

Toner application technology relies on toners having a monopolar charge, that is, having a predominantly negative or predominantly positive charge. A charge-control agent such as an alkyl pyridinium halide or a metal azo complex may therefore be included with the resin in the initial mixing stage, becoming incorporated into the toner particles, and/or a charge-modifying agent is mixed in as so-called post-additive (that is, a powder additive added to the toner powder produced after the extrusion or other homogenisation process). The prime example of this is silica. When the toner particles are charged, the charge-control agent, added during extrusion, influences the amount of charge and distribution of charge, that is, acts to shift the charge distribution in either the positive or negative direction as compared with the charge distribution in the absence of the additive. A charge-modifying agent, added as a post-additive, acts to modify the rate of charging and also assists fluidity.

Charging is accomplished, in the case of a single-component toner, by the friction between the toner particles and a friction surface of a doctor or stirrer blade. In the case of two-component toners, the toner is mixed with carrier particles (magnetic beads) to form the so-called developer compositions, charging being achieved by the friction between the toner particles and magnetic beads, with the carrier component being separated from the mixture during the printing process. Difficulties in producing the required charging properties can arise principally because the particle size, shape, pigmentation type and degree of pigment dispersion within the polymer all have a great influence on the electrostatic properties of the toner, but development of the required charge is essential to control the quantity of toner deposited during printing and hence control the colour being printed.

### BACKGROUND TO THE INVENTION

Because of the need for good image resolution, toners generally have a maximum particle size of about 30 μm, with a mean particle size of the order of 5 to 8 microns, but with such small particle sizes there are fluidity problems. To aid toner mobility, ultrafine particles (typically ≦3 μm) generated in the milling are therefore customarily removed, but the remaining particles are still very fine and will tend to agglomerate and exhibit poor fluidity, with consequential detrimental effects on the copying or printing process. For that reason it has become common practice in the art to incorporate a post-additive, in order to provide adequate fluidity. Examples of such fluidity-enhancing post-additives include aluminium oxide, titanium dioxide and, especially, silica, more particularly hydrophobic silica. Silica also acts as post-additive charge-modifying agent and therefore has dual function.

At concentrations of 2-3% by weight, hydrophobic silica is generally effective as a post-additive (i.e. for mixing in, post extrusion) for imparting satisfactory fluidity to toner compositions, but a number of problems have been observed, especially at the relatively high concentrations that can be necessary to impart adequate fluidity for certain toner systems, especially those of relatively fine particle size. In particular, it has been found that increasing concentrations of hydrophobic silica can have a detrimental effect on the charge distribution generated in the toner from tribostatic interaction, both in causing undesirable broadening of the distribution curve and in producing a distribution which is unstable and exhibits charge relaxation over time. The latter effect can lead to particular difficulties when a developer composition incorporating the toner, after charge relaxation to a low-charge condition, is replenished with fresh toner with the original high-charge distribution.

Similar difficulties may be encountered when using aluminium oxide as fluidity-enhancing post-additive. More particularly, the tribo-charging effect of aluminium oxide tends to be very sensitive to concentration variation up to concentrations of about 1% by weight and, at higher concentrations, aluminium oxide tends to cause electrostatic discharge and may also result in an undesirable seedy or grainy appearance in the fused toner film.

WO 2004/013703 discloses a toner composition having a particulate post-additive which comprises aluminium oxide and aluminium hydroxide and, advantageously, also as a third component, a tribo-charging additive which, upon tribo-charging of the toner particles, shifts the charge distribution in either the positive or negative direction as compared with the charge distribution in the absence of the additive, and which is advantageously a material which also functions as a fluidity-assisting additive for the toner particles. The third component is advantageously a silica or a wax.

The post-blended additives according to WO 2004/013703 give superior fluidity in the composition and permit a reduced level of silica to be used, but even with the reduced level of silica required when the aluminium oxide and aluminium hydroxide additives are used, some problems of charge relaxation over time remain.

It is an object of the present invention to alleviate the problems outlined above.

### SUMMARY OF THE INVENTION

The present invention pertains to a process for the preparation of a toner powder, in which particles of one or more toner base compositions are combined into larger particles. The larger particles manufactured via the process according to the invention do not break down under the mechanical and electrostatic forces encountered during toner use.

Generally, the agglomerated toner composition manufactured using the process according to the invention, excluding post-agglomeration additive(s), will have a percentage by number of particles below 3 microns which is at least 10% lower that the percentage by number of particles below 3 microns present in the toner base composition. Preferably, the percentage by number of particles below 3 microns is at least 15% lower than the percentage by number of particles below 3 microns present in the toner base composition, more preferably at least 20% lower, in particular at least 25% lower. For example, if the percentage by number of particles below 3 micron in the base composition was 50%, the percentage by number of particles below 3 microns in the agglomerated product is generally at most 40%, preferably at most 35%, more preferably at most 30%, in particular at most 25%.

In the agglomerated toner composition, the percentage by number of particles below 3 microns preferably is at most 35%, more preferably at most 31%, still more preferably at most 27%, more in particular at most 25%, still more preferably at most 20%, or at most 18%.

The d(n,50) of the agglomerated product is generally at least 10% higher than the d(n,50) of the base compositions, preferably at least 20%, more preferably at least 40%, still more preferably at least 50%, in particular at least 60%.

The toner base compositions may be in the form of dry powders, e.g., manufactured by jet milling or by freeze drying powder dispersions. In that case, the combination of the toner base compositions into larger particles may be done by, e.g., mechanofusion.

The toner base composition may also be in the form of an aqueous emulsion or dispersion. In that case, the combination of the base compositions into larger particles can be effected by spray-drying the emulsion or dispersion. In a preferred embodiment, the toner base composition in aqueous form is prepared via phase inversion emulsification, which preferably is carried out in an extruder.

The invention also pertains to a toner powder comprising composite particles in which individual particles of toner base composition(s) are fused or bonded together in the form of cluster structures that do not break down under the mechanical and electrostatic forces encountered during toner use. This can be obtained by mechanofusion of dry toner base powders.

The invention also pertains to a toner powder comprising composite particles in which individual particles of toner base composition(s) are fused or bonded together to form single substantially spherical particles. This can be obtained by spray drying of an aqueous emulsion or dispersion.

The toner powders of the present invention have increased fluidity as compared to conventional powders. Toners with different colours can be prepared in a simple and convenient manner.

Advantageously, a toner powder of the invention includes a mixture of aluminium oxide and aluminium hydroxide as post-additive for fluidity enhancement.

By combining the individual particles together into larger particles, the problems associated with ultrafine particles are removed. Thus, for example, powders produced by conventional jet milling may be combined by a mechanical fusion process or by dispersion and spray drying, and this avoids the need for removal of ultrafines by classification, which is expensive and difficult. The process of the invention also has the advantage of leading to less wastage of material.

Moreover, by combining differently coloured toner base powders, a more flexible production method is achieved and a range of colours can be produced. In comparison with the compositions described in WO 2004/013703 containing the aluminium oxide and aluminium hydroxide post-additive, powders of the present invention containing the same aluminium oxide and aluminium hydroxide post-additive have further improved fluidity and give a cleaner overall appearance. These improvements are also evident in comparison with compositions containing silica or aluminium oxide as the post additive, and, in comparison with those conventional prior art toners and with the compositions of WO 2004/013703, much reduced levels of silica are needed as post-additive, thus leading to improved retention of charge.

For combining of the powders into larger particles, an agglomeration process, may be carried out, for example, by mechanical fusion. In contrast to jet-milled powders, the particles of which resemble broken glass when viewed under an electron microscope, the particles of these mechanically-fused agglomerated powders are more generally rounded and have a composite, or cluster, structure, and, viewed under an electron microscope, it can be seen that their structure resembles that of a raspberry. Such macro-composite structures do not break down under the mechanical and/or electrostatic forces encountered when mixing and tumbling with the carrier, so the individual particles in the raspberry remain agglomerated in the cluster.

In a different embodiment, a liquid carrier, preferably aqueous, is used for the base powder to be combined, and the process includes the step of drying or otherwise removing the liquid carrier, agglomeration being carried out simultaneously, subsequently to or prior to this step. A phase inversion emulsification process carried out without organic solvent but with molten resin in water is especially useful in preparing the liquid base. Spray drying may then be carried out under conditions causing agglomeration to form the toner particles of the present invention. Powder dispersions prepared via phase inversion emulsification typically contain very small, spherical particles with a narrow particle size distribution, and by spray-drying such dispersions we have been able to obtain larger, agglomerated toner powders with a predictable particle size distribution which appear to include essentially single particles. It appears that the solids within each spray droplet can form a discrete powder particle so that, it is believed, the powder obtained comprises a substantial proportion of substantially spherical single particles with a smooth surface, although some cluster (macro-composite) structures appear to be formed by, it is believed, recirculation of particles in the spray zone of the spray-dryer. In an alternative process, drying—the removal of the liquid—may be carried out under non-agglomerative conditions, for example by freeze-drying, and the powder produced is agglomerated subsequently, for example by mechanical fusion, to provide composite toner particles of cluster structure.

The agglomeration processes of the invention allow particle size and shape to be controlled. Rounded, generally spherical particles are obtained which are either dusters or single particles. Without wishing to be bound by theory, we believe that the rounded, generally spherical shape, resulting from a constructive process for powder formation, in contrast to the usually destructive process (milling) for powder formation, as well as reduced levels of fine particles, contribute to the powder's improved fluidity.

Accordingly, the present invention provides a toner powder wherein the toner particles have been formed by a fusion-agglomeration process.

The present invention also provides a toner powder wherein the powder particles comprise clusters of particles in which individual particles of the toner base composition or compositions are fused or bonded together.

The present invention further provides a toner powder wherein the toner particles comprise discrete substantially spherical particles formed by a fusion agglomeration process.

In the clusters individual particles are combined, but remain separately identifiable in the cluster; in discrete particles, in contrast, complete fusion has taken place so that a single particle is formed.

U.S. Pat. No. 5,885,743 discloses a toner prepared by phase inversion emulsification of a resin-containing solution, the particles then being separated and dried; separation is by filtration, and drying is carried out by freeze-drying. No combining/agglomeration process is, however, carried out. EP 0797122 A also describes preparation of a toner powder in which an emulsified dispersion of the toner particles is prepared, separated and dried. There is no disclosure of an agglomeration/combining process. Preparation of a toner composition by emulsification of a dissolved binder polymer using an incompatible solvent to give toner-sized particles, followed by removing the solvent is also described in JP 11133659. There is again no combining, or agglomeration, process In contrast, in the embodiment of the present invention using a liquid carrier, drying is carried out under conditions causing particles to combine together, with the result that a substantial proportion of ultrafine particles below 1 μm are removed, or when a different drying step is carried out a subsequent agglomeration step is performed. An alternative method would be to carry out agglomeration and then dry. For reasons of process control, however, it is preferred for the carry out the agglomeration process during or after drying.

After agglomeration, the toner powder of the invention may be admixed with a particulate post-agglomeration additive or additives for improved fluidity and/or charge modification. A preferred post-agglomeration additive is a mixture of aluminium oxide and aluminium hydroxide as disclosed in WO 2004/013703. As mentioned in that specification, a third additive, having charge-modifying. tribo-charging properties, which is advantageously a material which also functions as a fluidity-assisting additive, may also be used. Thus, for example, silica, a wax, or a wax-coated silica may be used with the aluminium oxide and aluminium hydroxide as post-agglomeration additive(s) but in general limited amounts of the third additive are required. (Mixing a toner powder with hydrophobic inorganic particles is also mentioned in EP 0801333, but this is for gloss control, and the specification does not disclose combining toner base particles into larger particles.)

The charging behaviour of the toner of the invention can be tested and further post-additive charge-modifying or tribo-charging additive can be mixed with the toner until the required charging behaviour is produced.

Thereafter, if desired, the toner powder may be mixed with carrier particles to form the so-called developer compositions.

### DETAILED DESCRIPTION OF THE INVENTION

The powder agglomerated may comprise a toner binder resin composition, containing pigment and optionally containing a charge-control agent and/or a wax, and optionally also other suitable constituents.

Particles to be combined may be particles of a unitary powder or may be a mixture of two or more different powders. Usually, the powder agglomerated is a unitary powder. The powder may, for example, be derived from a single extrudate or obtained, for example, by extrusion of the same components in the same proportions, followed by comminution. A powder to be agglomerated may, for example, be mixed with a powder which is preferably substantially identical, the powder to be agglomerated comprising particles of substantially uniform composition. Alternatively, two or more different powders may be combined together. These may for example be of different colours. Powders for admixture may or may not have the same particle size distribution.

In one embodiment the present invention provides a process for preparing a coloured toner powder, which comprises:—
a. providing a set of toner bases of different colours;
b. selecting the bases to be used to obtain the intended colour;
c. mixing the selected bases in a ratio suitable to obtain the intended colour property; and optionally testing the mixture of bases for the desired end product colour and if necessary adjusting the mixing ratios and/or selection of the toner bases to be used, and
d. combining the particles of the toner bases.

Quality control of end product colour is possible, for example, by the simple expedient of applying the liquid mixtures on to a test sheet, drying and fusing, and examining the resulting product. The end product colour can then easily be controlled by addition of one or more toner bases to the existing mix or by adjusting the mixing ratio or by replacing one of the selected toner bases with a more suitable one.

For example, a kit of 4 or more, especially 5 or more, for example 10 or more, especially 15 or more, differently coloured toner base compositions may be prepared, and any two or more toner base compositions may then be combined in the agglomeration or other combining step in the production of the desired toner.

In general, the agglomerated toner composition, excluding post-agglomeration additive(s), will have a particle size distribution such that d(v,90) is ≦30 μm, more usually ≦20 μm, for example ≦15 μm. The d(v,90) is generally above 5 μm, preferably above 7 μm, more preferably above 10 μm, and still more preferably above 12 μm.

As will be understood in the art, the volume percentiles d(v,x) indicate for a stated particle size (d) the percentage (x) of the total volume of the particles that lies below the stated particle size; the percentage (100−x) of the total volume lies at or above the stated size. Thus, for instance, d(v,50) would be the median particle size of the sample, and on a particle size distribution graph d(v,90) is the point on the curve read along the particle size axis where the area under the curve below this particle size represents 90% by volume of the particles. Thus, d(v,90)=12 microns indicates that 90% of the particles are below 12 microns and 10% are above this size. d(n.x) indicates for a stated particle size (d) the percentage (x) of the total number of the particles that lies below the stated particle size. For the avoidance of doubt, it should be noted that all particle size percentages quoted herein are by volume, unless indicated otherwise. Particle sizes are measurable by Coulter Multisizer 2 or LS Particle Size Analyzer, or Aerosizer 3225, and unless indicated otherwise the toner sizes quoted here have been measured by the Multisizer 2, and particle sizes in liquid systems have been measured by the LS Particle Size Analyzer.

The agglomerated toner powder, excluding post-agglomeration additive(s), will usually have a d(v,50), also indicated as mean, of at least 3 μm, more in particular at least 5 μm, generally ≦30 μm for example ≦15 μm, often ≦8 μm, e.g. ≦7 μm. A mean in the range of from 5-7 μm or 5-8 μm should especially be mentioned.

A base toner composition for use according to the invention may be prepared in known manner by intimately mixing the ingredients, for example in an extruder at a temperature above the softening point of the resin, the extrudate then being milled, for example jet-milled, to produce a relatively fine particle size distribution. Unlike the prior art processes, however, it is not necessary to include a classification process, after jet milling, in which ultrafine particles (typically <3 microns) are removed; this represents a considerable commercial advantage.

The agglomerate may, for example, be prepared by mechanical fusion of the particulate toner base composition or compositions, for example by mechanical fusion at a temperature in the range of from 54 to 60° C., or by granulation using methanol or other suitable solvent as granulating agent, to produce cluster composite particles that constitute a free-flowing and fluidisable powder and in which individual particles are partially fused or bonded (effectively ‘glued’) together.

In one embodiment, the base powder is obtained by milling, especially by jet-milling; and the powder has a d(v,90)≦20 μm, preferably ≦15 μm, and/or a mean≦10 μm, preferably at least 3 μm, e.g. at least 5 μm, more especially 5-10 μm. As indicated above, the base powder can contain a substantial fraction of ultrafine particles resulting from dispensing with a classification process after jet milling. Thus, in one embodiment, the base powder may contain at least 30% by number of particles with a diameter below 3 μm, or even at least 35% by number, at least 40% by number, or at least 45% by number of particles with a diameter in this range.

In a different embodiment, a toner base composition is prepared in a liquid carrier and the composition or mixture of such compositions is dried or the liquid carrier(s) otherwise removed to form a toner powder, and the particles are agglomerated to provide powder of the desired particle size distribution. A preferred liquid carrier is water. Such compositions may be prepared, for example, by phase inversion emulsification, advantageously by phase inversion extrusion. Such methods have the advantage of reducing the number of process steps in toner manufacture, leading to a cost effective process, and allow good control of particle size, leading to a more consistent product with narrower particle size distribution

In this embodiment, the base powder(s) to be agglomerated, prepared in a liquid carrier, may have, for example, a particle size as follows: a d(v,90)<6 μm, preferably <5 μm, more especially <3 μm. The d(v,90) is preferably at least 0.2 μm, more preferably 0.5 μm. The range of from 0.5 to 3 μm should especially be mentioned. The base powder(s) of this embodiment generally have a mean<2 μm, preferably <1.5 μm, more especially in the range of from 0.1 to 2 μm, still more especially 0.1 to 1.5 μm. More especially, a base composition is prepared by phase inversion extrusion and the dispersion has a mean particle size<5 μm, preferably <4 μm, more preferably <3 μm, especially <2.5 μm, more especially <2 μm, very especially <1.5 μm, advantageously <1 μm, more advantageously <800 nm, very especially <500 nm. The dispersion preferably has a mean particle size of at least 100 nm. A preferred range is 100-1500 nm.

Agglomeration of the base composition(s) to give a toner powder with a d(v.90)≦15 μm, for example ≦14 μm, more in particular ≦13 μm, should especially be mentioned. The d(v,90) is generally above 5 μm, preferably above 7 μm, more preferably above 10 μm, and still more preferably above 12 μm.

The fines particles become combined with other particles to form larger particles that are discrete or of cluster structure.

In the toner resin market many different binder systems are available, for example styrene copolymers and polyester resins. Mixtures of resins may be used. Most of these are thermoplastic binder systems.

Suitable polyester resins are, for example, polycondensation products of difunctional organic acids with di-functional alcohols or aromatic dihydroxy compounds. Examples of difunctional acids which may be used include maleic acid, fumaric acid, terephthalic acid, and isophthalic acid. Examples of difunctional alcohols which may be used include ethylene glycol and triethylene glycol, and examples of aromatic dihydroxy compounds which may be used include Bisphenol A and alkoxylated bisphenols, for example propoxylated bisphenol. Toner powder compositions based on polyester resins are for example described in GB-A 1,373,220 (ICI America Inc).

Examples of suitable styrene copolymers include styrene-acrylate polymers, for example styrene/2-ethylhexylacrylate polymers, and styrene-methacrylate polymers, for example styrene/n-butyl methacrylate polymers. Styrene-acrylics are described, for example in U.S. Pat. No. 5,885,743 (Dainippon Ink and Chemicals Inc). Further examples of styrene copolymers include styrene/butadiene, styrene/maleic acid and styrene/itaconic acid polymers.

Other resins suitable for use in toner compositions may also be employed.

In a specific embodiment of the process according to the invention, the set of base compositions includes differently coloured base compositions. By adjusting the mixing ratio of a set of differently coloured base compositions a wide range of coloured products can be obtained. If desired, a coloured resin binder composition compatible with the first resin base composition may be used for colour tinting, for example of an uncoloured or white base composition or, especially if the additional composition is close in colour to the main coloured resin base composition, for colour adjustment of that composition.

The proportion of resin in a toner composition of the invention may be at least 40% and up to 99% or 100% by weight, based on the total weight of the composition without any post-agglomeration additive. The toner resin content usually is, however, at least 50%, preferably at least 60%, especially at least 70%, often at least 80%, by weight of the toner composition without any post-agglomeration additive.

The toner base composition to be agglomerated may or may not include a colouring agent and may or may not include, for example, one or more other materials, e.g. a charge-control agent and/or a wax, within the particles.

The colouring agent is typically a pigment or mixture of pigments, although dyestuffs can also be used. Suitable toner pigments include, for example, carbon black; phthalocyanine pigments; quinacridone pigments; azo pigments; rhodamine pigments; magnetites; and imidazolone pigments.

The colouring agents will generally provide one of four basic colours: black, yellow, cyan, and magenta, although more than four basic colours may be used in certain systems and it is an advantage of the present invention that more than four basic colours may be prepared easily on demand.

Specific examples of standard colouring agents include:
Toner Yellow HG, a benzimidazolone pigment from Clariant
Irgalite Blue PG, a cyan pigment from Ciba
Toner Magenta EO2, a quinacridone pigment from Clariant
Printex 70, a black pigment from Degussa

Examples of other pigments which may be used are inorganic pigments, such as, for example, titanium dioxide white, red and yellow iron oxides, chrome pigments and carbon black, and organic pigments such as, for example, phthalocyanine, azo, anthraquinone, thioindigo, isodibenzanthrone, triphendioxane and quinacridone pigments, vat dye pigments and lakes of acid, basic and mordant dyestuffs. Dyes may be used instead of or as well as pigments. A base composition may contain a single colorant (pigment or dye) or may contain more than one colorant.

Where a colouring agent is present in a toner composition of the invention, it may be in the range of from 1 to 60% by weight, based on the total weight of the composition without any post-agglomeration additive, and for example may be 1 to 50% by weight, relative to the weight of the toner without post-agglomeration additive, preferably 1 to 20 wt. %, more preferably 1 to 15 wt. %, still more preferably 1 to 10 wt. %.

Charge-control agents, for example alkyl pyridinium halides, are conventionally incorporated with the toner resin and pigment before the extrusion or other homogenisation process used in manufacture of the toner composition. According to the present invention, however, a charge-control agent, usually added pre-extrusion, may if desired be incorporated with toner resin particles by agglomeration.

A charge-control agent, if used, may be a positive or negative charge-control agent. Examples of positive charge-control agents include Nigrosine and onium salts. Examples of negative charge-control agents include metal azo complexes, salicylates and sulphonates. Suitable charge-control agents are commercially available, for example as NCA LP 2243 from Clariant, and a tribo-modified resin, such as a resin with hindered t-butylamine additive, may also be used in the pre-extrusion stage. It is an advantageous feature of the present invention, however, that it is in general not essential to incorporate a charge-control agent as a pre-extrusion ingredient. Thus, in the practice of the invention, both charge character and fluidity properties may be controlled primarily by means of the post-agglomeration additive as defined hereinbefore.

The proportion of charge-control agent incorporated in the toner agglomerate may be in the range of from 0 to 10% by weight, based on the total weight of the composition without post-agglomeration additive. If a charge-control agent is used, it is preferably used in an amount of 0.01 to 10 wt. %, more preferably 0.1 to 5 wt. %.

The use of a wax as a pre-extrusion ingredient in toner compositions of the invention may be advantageous, for example in providing lubrication in printing machines and also to increase the rub-resistance of, for example, labels printed using the compositions. Mixing in of wax to the final composition may also be carried out, as is known in the prior art. According to the present invention, the wax may alternatively be agglomerated with the base composition, which may be especially useful for providing lubrication in printing machines. Whatever stage of addition is used, the proportion of wax may, for example, be in the range of from 0 to 5% by weight, based on the total weight of the composition without post-agglomeration additive. If wax is used, it is preferably used in an amount of 0.01 to 5 wt. %, more preferably 0.1 to 3 wt. %.

The toner base compositions described in the process according to the invention can be prepared by many means known in the art, for example by jet milling in a fluid energy mill as is conventional for toner manufacture.

Alternatively, in the case of a base composition containing a liquid carrier, the composition may be a dispersion or emulsion, and these may be produced by any suitable process, for example wet grinding, emulsification or dispersion, more especially wet grinding of particles, phase inversion emulsification, melt dispersion, jet-dispersion, or emulsion polymerisation. The preparation of aqueous emulsions should especially be mentioned. Water-soluble ingredients, such as soluble binder resins may also be used.

The solids content of such base compositions is generally at least 0.001%, but usually at least 5%, preferably at least 10%, by weight; and preferably is at least 20%, often at least 30%, especially at least 40%, by weight. The upper limit on the solids content is governed by the viscosity of the composition, more especially if it is to be spray dried, and may be for example up to 70%, for example up to 60%, or, for example in the case of a very dense material, for example up to 95%, by weight.

The liquid carrier for the base compositions of this invention is preferably not reactive and not miscible with the binder particles. Aliphatic hydrocarbons can be used as a dispersing medium, for instance liquid alkanes, such as hexane, heptane or octane. However high-boiling alkanes such as nonane, decane, dodecane, or isohexadecane are preferred if an organic solvent is used. Water-borne base compositions, especially those that are free of organic solvents, are preferred.

To improve dispersibility, the resin may contain self-emulsifiable groups. It has been found that this helps to produce smaller particle sizes in the dispersed phase. Suitable examples of such self-emulsifiable groups are acid-functional groups, such as carboxylic acid-, sulphonic acid- or phosphonic acid-functional groups.

The aqueous medium may contain one or more dispersing agents to promote homogeneous dispersion and the formation of particles with a uniform particle size and shape. Any suitable dispersing agent may be used, for example anionic, cationic, amphoteric or nonionic compounds or combinations thereof. It may be advantageous to use dispersing agents with functional groups capable of reacting with the resin or to use only limited amounts of non-reactive dispersing agents with high dispersing/stabilising properties. Alternatively, or additionally, neutralising agents can be used which can ionise the functional groups (e.g., carboxylic groups, sulphonate groups and/or phosphonate groups) which are present in the resin. Typical examples of such neutralising agents are amines, ammonia, ammonium hydroxide, and alkali metal hydroxides. Preferably, volatile neutralising agents are used. Organic amines, preferably tertiary amines, for example dimethylethanolamine and triethylamine, are suitable examples.

The neutralising agent is suitably used in an amount to ensure partial neutralisation for example of 35 to 75%, often at least 40%, and often no more than 60%, for example substantially 50%, of the functional groups present on the resin. For example, in the case of an acid-functional polyester resin or other polymer the neutralising agent dimethylethanolamine may be used in an amount to react with substantially 50% of the carboxylic acid groups of the polyester, although with a higher acid number a lower neutralisation degree is appropriate. With a polyester of acid value in the range of from 5 to 75 mg KOH/g, the anionic groups may be, for example, from 0.09 to 1.3 mmol/g.

The use of dispersing agents with reactive groups or the use of neutralising agents which can form anions with functional groups present on the binder enables the preparation of dispersions with an average particle size in the range from 50 to 1500 nm and a solids content in the range of 30-70 wt. %, more especially in the range of from 40 to 60 wt. %, e.g. from 50 to 60 wt. %.

In a particularly preferred embodiment of this invention, a base composition comprising resin is prepared by phase inversion emulsification of the starting materials that make up the toner. In the process of phase inversion emulsification, also known as indirect emulsification, water is added to a binder to form a water-in-oil emulsion which, after the addition of sufficient water, turns into an oil-in-water emulsion. It has been found that such a process gives a very homogeneous distribution of the material(s) used and allows optimum control of particle morphology. Toner dispersions prepared via phase inversion emulsification typically contain very small, spherical particles with a narrow particle size distribution.

In one embodiment a molten binder is used in the emulsification process. In this case, evaporation of water and/or build-up of pressure in the process equipment should be taken into account.

A particularly suitable phase inversion emulsification process is phase inversion extrusion. In this process polymer melts are processed using an extruder, preferably a twin-screw extruder. Such extruders are routinely used for compounding pigments and resins and can be adapted for liquid additions for dispersing such a toner-based powder in an aqueous medium. This gives improved control of the dispersion's average particle size, particle size distribution, and particle shape. Preferably, the extrusion apparatus used includes a feeding port, an exit port, and options to add additional liquids. In a preferred embodiment a stepped concentration gradient is produced in the apparatus, one or preferably two separate additions of liquid being made. Thus, for example, the resin binder and optional pigment, and/or other solid constituents are added at the feeding port, and water and neutralising agent are added at a later inlet to give a composition containing about 70 to 90% by wt solids. Further water is then added subsequently at a further inlet so that the resulting composition has a content of substantially 40-60% solids.

Particle sizes in the liquid base can be obtained by choosing the right conditions, such as mixing speed, type and number of, for example, mixing and/or transporting elements in the apparatus, solids content, temperature, pressure, etc.

A degree of particle size control has also been found in the phase inversion emulsification of binder components by controlling the hydrophilic and hydrophobic properties of the resin, for example by controlling the degree of neutralisation, for example through controlling the stoichiometric ratio of neutralising agent introduced in the aqueous phase to ionisable functional groups of the binder resin.

The preparation of base dispersions with low particle sizes, and subsequent agglomeration of the small-sized particles into substantially larger particles in the drying step or subsequently contrasts with the processes of EP 0797122 and U.S. Pat. No. 5,885,743 and JP 11-133659 A prior art patents described above.

When two or more base compositions and/or a charge-control agent or wax are to be incorporated into the agglomerate, mixing of the toner base composition with the one or more other toner base compositions and/or charge-control agent or wax may be carried out by various techniques, for example by dry mixing in a high-shear mixer or a fluid energy mill. A Henschel mixer type MB may also be used. Mixing may be achieved by any means known to those skilled in the art and can be carried out in a wide variety of known mixing apparatus in a ratio suitable to obtain the intended end product property. Examples of suitable mixing apparatus are described in Perry's Chemical Engineers Handbook by Perry & Green, published by McGraw-Hill in 1997. For example, for liquid base compositions a stirred tank or an in-line mixer such as a static mixer may be used.

In the case of liquid dispersions, optionally, an anti-blocking or anti-agglomeration treatment may be carried out to retain the dispersed particle size distribution in the dry product. Such processes are described, for example, in Polymeric stabilisation of colloidal dispersions, by Donald H. Napper, Academic Press of London, 1983, and other methods have more recently been developed, such as the method of inorganic anti-blocking proposed in JP-A 07-053728 or by the use of solid particles as surfactants as described by B P Binks in Current Opinion in Colloid and Interface Science 7 (2002) 2141, published by Elsevier. After removal of liquid, agglomeration is then carried out subsequently, for example by mechanical fusion.

Drying of a liquid base composition is preferably done by spray-drying, although other drying techniques, for example rotary drying and freeze-drying may be used if so desired. Spray drying is particularly suitable if no measures are taken to prevent agglomeration of the dispersed particles into larger particles. Spray drying may be followed by secondary drying to remove bound water, for example using a fluidised bed. Where combining/agglomeration of the dispersed materials takes place when producing powders by spray drying, the atomisation process and the carrier content control the particle size of the powder produced. Suitable atomising conditions are, for example, an inlet temperature of 180° C., and an outlet temperature of 55 to 60° C. Spray drying is particularly suitable for producing toners with d(v,90) values around 10 μm. However, for producing smaller particle sizes, dilution of the dispersion and fine atomisation can produce particles substantially below 10 μm.

In a different embodiment, a rotary film dryer can be used for drying the base composition to form the end product. Where effective anti-agglomeration measures are applied and no agglomeration takes place at this stage, a rotary film dryer is generally more efficient, as the efficiency of direct heating is superior to the use of air as a heat exchange medium. Also the problematic collection of the toner and the separation of the toner from moist air are avoided. This is especially the case for the production of micron and sub-micron particles (later to be agglomerated).

Freeze drying separates the particles from water by converting the water first into ice, which is then extracted by sublimation at a reduced pressure. The formation of interstitial ice can be used as an anti-coagulation (or anti-agglomeration) stage. Subsequent agglomeration is needed. Lyophilisation is a special type of freeze drying described in detail by Thomas Jennings in Lyophilisation—Introduction and Basic Principles (Technomic Publishing AG, Switzerland). Lyophilisation is particularly advantageous if the concentration of any salts and dissolved organic solvents as a result of ice formation presents a problem. In lyophilisation, the temperature is maintained such that all the interstitial liquid is solidified. Hence the particles are first separated from the entire dispersing medium before and during sublimation.

Filtration, centrifugal separation and evaporation may also be used when an anti-agglomeration technique is used; the product is then agglomerated subsequently.

With freeze drying and any other drying technique that does not produce agglomeration, the toner is then agglomerated after drying to increase the particle size, which leads to greater fluidity during handling and application. Agglomeration can also be carried out in the emulsion or dispersion, with drying carried out subsequently.

Agglomeration of such powders or of other powders, for example a toner base produced by jet-milling post-extrusion, optionally together with particles of wax or charge-control agent, may be carried out by generally known techniques.

Agglomeration may be carried out, for example, by mechanical fusion, for example by mechanical fusion at a temperature in the range of from 45 to 60° C.

For any given starting powder, the precise particle size distribution of the agglomerated powder will depend on a number of factors, for example, for mechanical fusion, the temperature of, and time for, the mechanical fusion operation, the rate of heating, the Tg of the resin and free space inside the mechanical fusion device and the shear force in the mechanical fusion device (determined by the power/current used).

In general, for example, mechanical fusion may be carried out at or just above the glass transition temperature of the toner resin, for example using a heater temperature at or just above the Tg of the polymer present in the toner, for example at the Tg temperature plus up to 10 degrees C., e.g. up to 8 degrees C., above the Tg. Typically the heater is set to the maximum temperature desired for the powder used. The toner may, for example, be heated to a maximum temperature in the range of its Tg to Tg+10° C. preferably Tg to Tg+5° C., more especially Tg to Tg+2° C. Typically, a maximum temperature in the range of 54 to 60° C. is used.

The powder may then be cooled immediately, or may be held at the maximum temperature for a short period, generally no more than 5 mins, especially no more than 2 mins, Overall, the heating process or overall time before cooling generally takes more than 5 mins and usually no more than 120 mins, especially no more than 60 mins, for example about 40 mins or, especially, 30 mins. The powder may be at a temperature at or above its Tg for a time of, for example, 2 mins, for example 5 mins, or more. The time will, of course, be adjusted according to the temperature used and other conditions. Increased temperature or a longer time bring about more bonding, and thus remove more fines. Relatively gentle conditions are preferred. The heating conditions may be set by adjustment of the heater temperature and blade speed so as to heat the powder to the desired temperature at a relatively low rate, especially over the temperature range approaching the Tg or the desired maximum temperature. For example, from a temperature at least 4° C. below the Tg, e.g. about 10° C. to 5° C. below the Tg, up to the maximum final temperature, or from a temperature 15° C. below the final temperature, to that final temperature, the heating rate is advantageously kept low. The rate of heating at least during that time may, for example, be ≦4° C. per min, preferably ≦3.5° C. per min, especially ≦3° C. per min, very especially ≦2.5° C. per min, advantageously ≦2° C. per min, e.g. 1° C. per min, the higher rates, if used, being preferably used at lower temperatures. Thus, for example, heating may be carried out at a rate of about 1 to 2° C. per minute at temperatures in the range 4 to 7° C. below the final temperature up to the final temperature, especially over the final 5° C. before the desired temperature is reached. Adjustment of conditions can be carried out automatically on larger machines. If desired, the temperature increase to the desired final temperature may be carried out in stages, with the very final heating rate, e.g. from a temperature 2 to 3° C. below the Tg up to the final temperature, being reduced, e.g. to give a temperature rise of only about 1° C. per minute. In general, higher heating rates near the maximum would usually only be used with a lower maximum temperature (and therefore usually longer holding times at that maximum temperature). When the maximum temperature is reached, the conditions are then suitably adjusted to cool the powder or to maintain the temperature constant for the desired period, e.g. for 2 mins, followed preferably by cooling, cooling being carried out, for example, with a low speed of agitation, for example over a period of about 10 to 15 minutes.

More especially, the final toner composition includes a particulate post-agglomeration additive or additives to improve fluidity and/or tribo-charging or charge-modifying properties. Such additives are simply blended with the toner powder and not agglomerated with the powder. Often such additives have dual function. Examples are aluminium oxide, titanium dioxide and, especially, silica, more particularly hydrophobic silica.

Preferably, the post-agglomeration additive comprises aluminium oxide and aluminium hydroxide, used primarily to assist fluidity, although the aluminium oxide also assists charge distribution. Advantageously a third additive, especially hydrophobic silica, is also used to modify charging properties.

Especially in the case in which the post-agglomeration particulate additive includes hydrophobic silica or other material with tribo-charging properties, charge control may be achieved solely by adjustment of the proportions of the components of this post-agglomeration additive. The possibility of relying solely on a post-agglomeration additive approach for achieving charge control facilitates matching of toner compositions to particular end uses. Thus, in the practice of the invention, both charge character (and charging rate) and fluidity properties may be controlled primarily by means of the post-agglomeration additive(s). No pre-extrusion charge-control additive is essential, although it may be preferable for the toner composition to include such a material. In one embodiment, typically a charge-control agent, a tribo-modified resin, a wax material, or a pigment is used, which may be extruded with resin; such a material may alternatively be incorporated by agglomeration. In such cases there is in general less need for silica or other secondary tribo-charging post-agglomeration additive.

A post-agglomeration agent with tribo-charging properties also functions as a fluidity-assisting additive for the toner particles. The tribo-charging or charge-modifying agent is advantageously a silica, preferably a hydrophobic silica, but may instead be another material fulfilling the specified charge control function and compatible for use in toner compositions, for example a wax. A wax-coated silica may be used. Further details are given in WO 2004/013703.

Preferably, the toner composition uses as post-agglomeration additive a mixture of aluminium oxide and aluminium hydroxide and hydrophobic silica.

The particle size of each post-agglomeration additive component may be in the range of from 0.01 to 10 μm, for example from 0.1 to 10 μm, preferably from 0.5 to 2 μm, and should as a generality be below that of the agglomerated toner particles themselves. By way of exception, however, larger particles can in principle be used in the case of tribo-charging additive materials such as waxes that will melt under the application conditions of, for example, an electrostatic printing or copying process.

Typically, the particle size of the aluminium oxide will be ≦0.2 microns and the particle size of the aluminium hydroxide will be in the range of from 0.9 to 1.3 microns.

The total amount of the post-agglomeration additive may be in the range of from 0.1 to 25% by weight, based on the weight of the toner composition without the additive, advantageously from 1 to 15% by weight, preferably ≦10% by weight, especially ≦8% by weight, for example 1 to 5%, and amounts of at least 2%, e.g. 2 to 4%, and of up to 3%, e.g. 1 to 3%, should be mentioned. As a generality, the smaller the particle size of the toner composition, the greater the amount of the post-agglomeration additive that will be needed in order to ensure satisfactory fluidity.

It is believed that any of the main structural types of aluminium oxide and aluminium hydroxide (and/or aluminium oxyhydroxide) may be used, that is to say:
α-Al₂O₃ Corundum
α-AlO(OH) Diaspore
α-Al(OH)₃ Bayerite
γ-Al₂O₃
γ-AlO(OH) Boehmite
γ-Al(OH)₃ Gibbsite.

Preference may be given to γ-structural types.

The ratio by weight of aluminium hydroxide to aluminium oxide in the post-agglomeration additive may be in the range of from 1:99 to 99:1, advantageously from 50:50 to 99:1, for example from 50:50 to 90:10 or 80:20, or from 40:60 to 80:20. A ratio of from 40:60 to 90:10 may be mentioned. This mixture may be present in an amount, for example, of from 0.5% to 5%, especially 1% to 2%, by weight of the toner composition without the additive.

A tribo-charging/charge-modifying agent used as third component of a post-agglomeration additive may constitute from 1% to 99% by weight of the total post-agglomeration additive, preferably from 1% to 70% by weight, e.g. from 10% to 60% by weight, advantageously 20% to 60%, e.g. substantially 40% or 40% to 50%, by weight, and the agent may be mixed with the toner in an amount for example of ≦3% by weight, e.g. at least 0.2% by weight, and preferably from 0.2% to 2% by weight, calculated on the toner composition without the additive.

By way of example, the post-agglomeration additive may comprise 45% by weight of aluminium hydroxide, 15% by weight of aluminium oxide and 40% by weight of a hydrophobic silica charge-modifying additive, and may be added to the toner in an amount of substantially 2% by weight, for example.

In general, it will be found that the following relationships apply:
the higher the aluminium oxide concentration in the post-agglomeration additive combination, the greater will be the fluidity of the toner composition
the higher the concentration of aluminium hydroxide in the post-agglomeration additive combination, the less sensitive to concentration will be the tribo-charging effect of a tribo-charging additive used as third component, especially silica
the higher the concentration of the total post-agglomeration additive combination, the better will be the fluidity of the toner composition.

Although any component of the post-agglomeration additive, or mixed sub-combination of components, may in principle be blended separately with the toner composition, pre-mixing of additives is generally preferred. Also, in the case in which a tribo-charging or charge-modifying agent is used as a third component in addition to the aluminium oxide and aluminium hydroxide, it is generally advantageous to pre-mix the aluminium oxide and aluminium hydroxide before mixing-in the third.

Pre-mixing of the additive components in the case where a tribo-charging or charge-modifying component is used has the advantage of lessening the (otherwise) relatively high charge-to-concentration dependence of the tribo-charging component. As a result, relatively high levels of a three-component additive can be incorporated with a toner composition without a correspondingly large increase in charge being generated. This is advantageous where relatively high levels of post-agglomeration blended additive are required for fluidity purposes, and furthermore is advantageous in manufacturing, by making the toner charge less susceptible to small variations in post-agglomeration additive concentration.

The post-agglomeration blended additive, or any component thereof, may be incorporated with the toner composition by any suitable blending method, for example blending in a “tumbler” or other suitable mixing device.

Alternatively, wax or a charge-control agent may be agglomerated in, but more usually the agglomeration process of the invention is carried out with the particles of toner base without addition of such materials. Mechanical fusion of a jet-milled unitary powder or spray-drying of a liquid dispersion or emulsion containing a unitary base should especially be mentioned.

In addition to providing toner compositions of excellent fluidity, the process of the present invention offers the further advantages:
1) Especially in the case in which a post-agglomeration particulate additive comprises aluminium oxide, aluminium hydroxide and a tribo-charging or charge-modifying third component as specified above, charge control may be achieved solely by adjustment of the proportions of the components of the post-agglomeration additive. No pre-extrusion charge-control additive is needed although, in the case of a two-component additive comprising aluminium oxide and aluminium hydroxide, it is preferable for the toner composition to include such a material, typically a charge-control agent, a tribo-modified resin, a wax material, or a pigment, so there is then in general no need for a secondary charge-control post-agglomeration additive.
2) Lower amounts of silica or other additive are required to achieve the same fluidity. Thus, the undesirable effects on charge distribution and stability of distribution, observed hitherto at increasing concentrations of, for example, silica as post-additive, and the undesirable concentration dependence of tribostatic charge distribution observed especially at relatively low concentrations of aluminium oxide, are substantially reduced or even eliminated. In comparison with the process of WO 2004/013703, even lower amounts of silica are required to achieve the same excellent result.

The present invention also provides a developer composition which comprises a toner powder of the invention, in admixture with carrier particles.

The carrier particles will in general be conductive and may comprise, for example, a ferrite (nickel zinc, copper zinc, or manganese), iron powder or magnetite powder.

Typically, the particle size distribution of the carrier particles will be such that d(v)₉₀ is in the range of 50 to 100 microns.

The carrier particles may be coated or uncoated. Preferably, however, the particles are coated with a material which assists in tribo-charging of the toner, acts as a protective coating to prolong the active life of the carrier and/or alters the resistivity (conductivity) of the carrier. For positive-charging applications the coating materials are typically fluoropolymer-based, and for negative-charging applications the coating materials are typically acrylic materials or silicones. Suitable carrier materials are commercially available.

The charge distribution in tribo-charged toner compositions of the invention may be assessed using a charge spectrometer such as the Espart by Hosokawa.

Toner and developer compositions according to the invention may in principle be used in any electrostatic copying or printing process, such as xerography, electrophotography, electrography and digital printing. Matching of the toner/developer compositions to particular end uses is facilitated by the control of both fluidity and tribo-charging characteristics achieved in the present invention.

The invention is also applicable to other image development processes, for example magnetography, where control of fluidity and charge control is required. Ionography may also be mentioned.

Application of the toner powder to the substrate may be by any “dry” powder development method as described, for example, in EP 0 601 235 A1.

Both “contact” and “non-contact” fusing processes come into consideration, and reference is made to EP 0 601 235 A1 for further information in this respect.

The present invention further provides use of a toner composition or a developer composition of the invention in an electrostatic copying or printing process.

It will be appreciated that the present invention is not concerned with solvent or liquid-containing toner systems, because the presence of solvent or liquid would inherently nullify the principal objectives of the invention, namely the achievement of adequate fluidity of fine toner powder compositions, and control of the electrostatic charge generated on such powder by tribostatic interaction.

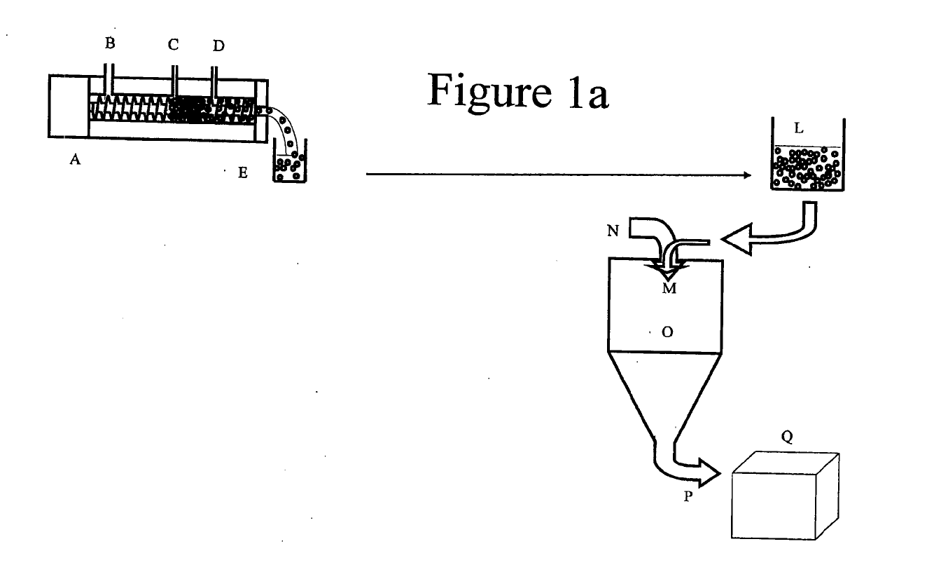

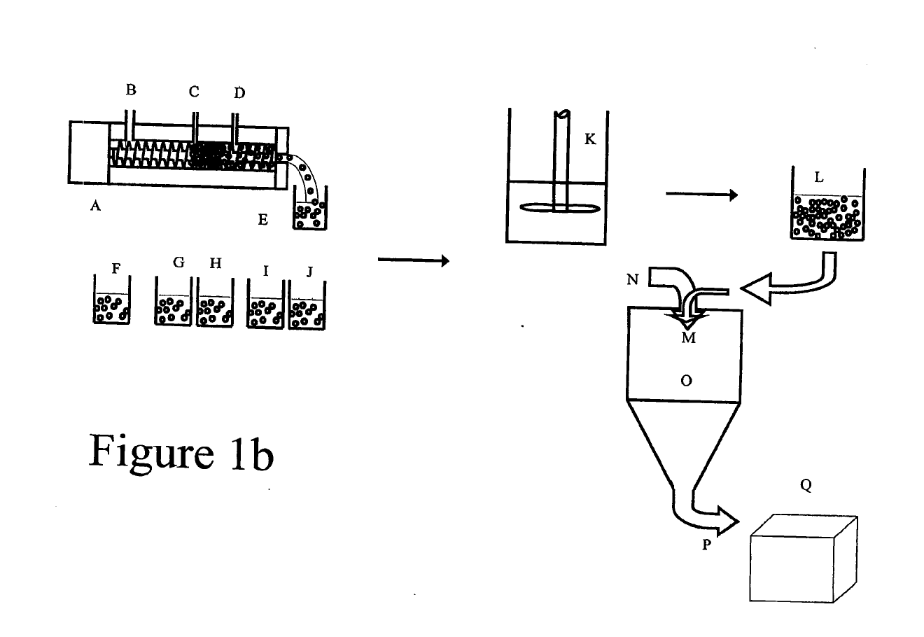

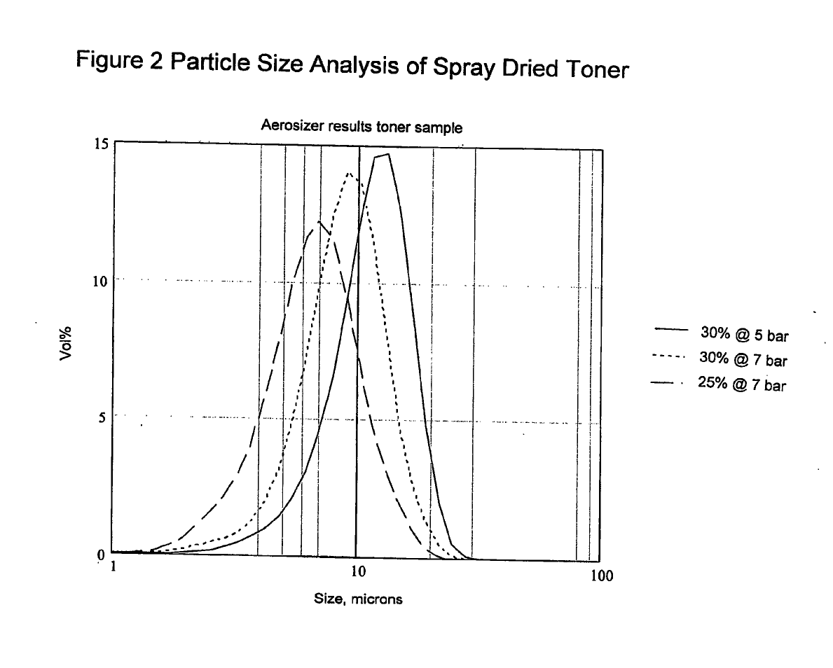

The invention is further described and illustrated in FIGS. 1a, 1b, and 2 of the accompanying drawings in which:

FIGS. 1a and 1b shows a schematic representation of some of the preferred embodiments of the process according to the invention.

FIG. 2 shows the particle size distribution measured by Aerosizer of representative toner compositions produced according to the invention by spray drying of liquid emulsions or dispersions under different conditions.

In FIGS. 1a and 1b extruder A is fed through the main inlet B with the toner material which is melt mixed. At point C along the extruder barrel, water and emulsifiers are introduced to the extruder to form a water-in-oil type dispersion. Further along the extruder at point D secondary water is added to the extruder, which causes phase inversion such that the water-in-oil phase is inverted to an oil-in-water type dispersion and stored in vessel L. In FIG. 1b, one or more similar dispersions, represented by F, G, H, I and/or J, may be produced with different pigmentation, and a selection of some or all of these dispersions may be made, depending on the required final toner colour. The selected bases are mixed in the required proportions in mixer K to form a mixture stored in vessel L.

The toner dispersion E from FIG. 1a or mixture from 1b is pumped to the spray nozzle M which is supplied with hot air N into the drying chamber O where evaporation of water dries the spray droplets and cools the air such that dry toner and warm air exit the dryer at P. The powder product is separated from the air stream and collected at Q.

FIG. 2 shows that particle size distribution curves shift towards higher sizes with decreasing atomisation pressure and with increased solids content of the starting emulsion. Thus the maximum particle sizes, d(v,90) and mean particle sizes all increase. The continuous line shows the distribution of a toner sample produced from a 30% solids dispersion with atomisation pressure of 5 bar; the dotted line shows the distribution of a toner sample produced from a 30% solids dispersion with atomisation pressure of 7 bar, and the broken line shows the distribution of a toner sample produced from a 25% solids dispersion with atomisation pressure of 7 bar. Taking these trends into account it is within the scope of the skilled person to determine the optimum spray drying conditions for his particular case.

The following Examples illustrate the invention.

### EXAMPLES

### Test Methods

Viscosity of the binders described was measured by ISO 53229

Particle size was measured for liquid systems using a Coulter LS230 particle sizer and for dry powders using a TSI Aerosizer 3225. Particle shape of toner bases was determined by scanning electron microscopy.

Colour was measured according to industrial standard ASTM D65, using L, a, b coordinates.

All amounts of contents are given in grams, unless indicated otherwise.

Starting materials used in the Examples are available as indicated below.

| | |
|---|---|
| Garamite ® 1958 | anti-blocking agent, available from Laporte; |
| Heucosin ® Fast | cyan pigment, available from Heubach; |
| Blue G1737 | |
| NCA ® LP2243 | charge-control agent, available from Clariant; |
| P382ES | polyester resin with an acid number of 21 mg/g |
| | KOH, available from Reichold Inc. |
| Sicopal ® L1100 | yellow pigment, available from BASF |

### Preparation of Base Toner Compositions

### Preparation Example A

### Preparation of a Powder Base Composition Containing a Cyan Toner without Charge-Control Agent by Jet-Milling

A cyan toner base formulation was prepared by mixing 95 parts by weight of polyester resin (P382ES®) with 5 parts by weight of pigment Irgalite Blue GLC (Ciba Geigy). The total was extruded and jet-milled to give a particle size distribution of d(v,10) 2.98 μm, d(v,50) 5.47 μm, d(v,90) 9.61 μm

### Preparation Example B

### Preparation of Powder Base Composition Containing Cyan Toner by Jet-Milling

6 kg of cyan toner was prepared by mixing 930 parts by weight of a polyester resin P382ES with an acid number of 21 mg KOH·g, 50 parts by weight of Heucosin® Fast Blue G1737 and 20 parts by weight of NCA® LP2243, extruding, then jet-milling the materials to produce a toner with particle size d(v,90)=13.01 μm, d(v,50)=8.636 μm, d(v,10)=4.96 μm.

### Preparation Example C

### Preparation of a Liquid Base Composition Containing Cyan Toner

A cyan base composition of a pigmented toner powder was prepared by feeding 1000 grams of a pre-extruded toner powder having the composition given in Preparation Example B to an extruder which was heated up to a temperature of about 110° C. After cooling down the melted mixture to 90° C., in the first feeding point of the extruder 100 grams of an aqueous solution containing 12.5% by weight of dimethylethanolamine and 173 grams water were added at a constant rate. Just before the end of the extruder, at a next feeding point, 1020 grams of water was added thereby obtaining a blue dispersion with a solids content of around 44 wt. % and a pH of 7.2. Spherical-like particles were produced having a mean particle size of 288 nm.

### Preparation Example D

### Preparation of a Liquid Base Composition Containing a Yellow Toner

A yellow base composition of a pigmented toner powder was prepared by feeding 1000 g of a pre-extruded toner powder composition comprising 910 grams of a polyester resin P382ES®, 70 grams of Sicopal® L1100 and 20 grams of NCA® LP2243 to an extruder which was heated up to a temperature of about 110° C. After cooling down the molten mixture to 90° C., in the first feeding point of the extruder 100 grams of an aqueous solution containing 12.5% by weight of dimethylethanolamine and 196 grams of water were added at a constant rate. Just before the end of the extruder, at a next feeding point, 1024 grams of water was added, thereby obtaining a yellow dispersion with a solids content of around 41 wt. % and a pH of 6.9. The mean particle size was 269 nm.

### Preparation Example E

### Preparation of a Liquid Base Composition Containing a Cyan Toner without Charge-Control Agent

A cyan base composition of a pigmented toner powder was prepared by feeding 1000 grams of a pre-extruded toner powder composition consisting of the following ingredients: 900 grams of a polyester resin P382ES with an acid number of 21 mg·KOH·g, and 100 grams of Heucosin® Fast Blue G1737 to an extruder which was heated up to a temperature of about 110° C. After cooling down the melted mixture to 90° C., in the first feeding point of the extruder 100 grams of an aqueous solution containing 12.5% by weight of dimethylethanolamine and 173 grams water were added at a constant rate. Just before the end of the extruder, at a next feeding point, 1020 grams of water was added thereby obtaining a blue dispersion with a solids content of around 47 wt. % and a pH of 7.2. The mean particle size was 298 nm.

### Preparation Example F

### Preparation of a Liquid Base Composition Containing a Yellow Toner without Charge-Control Agent

A yellow base composition of a pigmented toner powder was prepared by feeding 1000 grams of a pre-extruded toner powder composition consisting of the following ingredients: 900 grams of a polyester resin P382ES with an acid number of 21 mg·KOH·g, and 100 grams of Sicopal® L1100 to an extruder which was heated up to a temperature of about 110° C. After cooling down the melted mixture to 90° C., in the first feeding point of the extruder 100 grams of an aqueous solution containing 12.5% by weight of dimethylethanolamine and 173 grams water were added at a constant rate. Just before the end of the extruder, at a next feeding point, 1020 grams of water was added thereby obtaining a blue dispersion with a solids content of around 47 wt. % and a pH of 7.2. The mean particle size was 298 nm.

### Preparation Example G

### Preparation of a Powder Base Composition Containing a Black Toner without Charge-Control Agent by Jet-Milling

A toner black powder was made to the following formulation and manufactured by the standard method described earlier.

| | |
|---|---|
| Polyester Resin | 92.5% |
| Pigment Black (Degussa Nippex 70) | 6.0% |
| Pigment Blue (Ciba Irgalite PG) | 1.5% |

3000 g of the powder was jet-milled to a particle size d(v,90)=11.19 μm, mean=7.318 μm, d(v,10)=4.52 μm.

### Preparation of Toner Compositions

### Example 1

### Preparation of Cyan Toner without Charge-Control Agent by Mechanical Fusion

1500 g of the jet-milled toner base formulation according to Preparation Example A was placed in a Mixago CM3 mechanical fusion instrument to 50% capacity. The external heating water was set at 55° C. (the Tg of the powder) and the sample was mixed for 20 minutes with control of the blade speed until the toner base reached a temperature of 55° C. Mixing was continued for 2 minutes at that temperature after which the toner base was allowed to cool with a low speed of agitation. The particle size of the toner base was measured to be d(v,10) 4.61 μm, d(v,50) 7.26 μm, d(v,90) 11.32 μm.

### Example 2

### Preparation of a Cyan Toner by Mechanical Fusion

3 kg of the jet-milled toner based according to Preparation Example B was bonded using a Mixago CM3 under the conditions of Example 1 to give a particle size d(v,90)=14.91 μm, d(v,50)=10.19 μm, d(v,10)=6.36 μm.

### Example 3

### Preparation of a Cyan Toner by Spray-Drying

A toner dispersion prepared according to Preparation Example C was diluted to 25% solids and then spray dried at a rate of 2.4 kg/h using a compact laboratory spray dryer by Drytec, of Tonbridge, Kent, in co-current mode using a 60/100/120 2-fluid (air) atomiser operating at 7 bar g (inlet air temperature of 150° C., outlet temperature 70° C.) to give a uniform blue toner with d(v,90)=11.11 μm and the mean particle size was 7.08 μm.

### Example 4

### Preparation of a Yellow Toner by Spray-Drying

A toner dispersion prepared according to Preparation Example D was diluted to 30% solids and then spray dried at a rate of 2.4 kg/h using a compact laboratory spray dryer by Drytec, of Tonbridge, Kent, in co-current mode using a 60/100/120 2-fluid (air) atomiser operating at 5 bar g (inlet air temperature of 150° C., outlet temperature 70° C.) to give a uniform yellow toner with d(v,90)=17.22 μm and the mean particle size was 11.85 μm.

### Example 5

### Preparation of a Blue Toner without Charge-Control Agent by Spray-Drying

A toner dispersion prepared according to Preparation Example E was diluted to 15% solids and then spray dried at a rate of 3.68 kg/h using a compact laboratory spray dryer by Drytec, of Tonbridge, Kent, in co-current mode using a 60/100/120 2-fluid (air) atomiser operating at 5 bar g (inlet air temperature of 150° C., outlet temperature 70° C.) to give a uniform yellow toner with d(v,90)=25.44 and mean particle size 17.03 μm.

### Example 6

### Preparation of a Yellow Toner without Charge-Control Agent by Spray-Drying

A toner dispersion prepared according to Preparation Example F was diluted to 20% solids and then spray dried at a rate of 3.57 kg/h using a compact laboratory spray dryer by Drytec, of Tonbridge, Kent, in co-current mode using a 60/100/120 2-fluid (air) atomiser operating at 4 bar g. (inlet air temperature of 150° C., outlet temperature 70° C.) to give a uniform yellow toner with d(v,90)=19.62 and the mean particle size was 13.51 μm.

### Example 7

### Preparation of Black Toner by Mechanical Fusion

1500 g of the powder from Preparation Example G was agglomerated using a Mixago CM3 agglomerator. The thermostatically-controlled heating jacket of the CM3 agglomerator was set to a temperature of 57° C. (the Tg of the powder) and the mixer blade rotation speed was set to give a temperature rise of 2° C. per min during the agglomeration process. When the powder temperature had reached 57° C. the powder was kept at this temperature for two minutes to effect full agglomeration. The particle size of this toner was determined by Coulter Multisizer II: d(v,90)=13.85 μm, mean=9.21 μm, d(v,10)=5.86 μm.

### Example 8

### Preparation of a Mixed Colour Toner by Spray-Drying

Toner dispersions prepared according to Preparation Examples C and D were mixed in the mixing ratio 25:75 and spray dried. The mixture was diluted to 40% solids and then spray dried at a rate 4.2 kg/h using a compact laboratory spray dryer by Drytec, of Tonbridge, Kent, in co-current mode using a 60/100/120 2-fluid (air) atomiser operating at 7 bar g (inlet air temperature of 150° C., outlet temperature 70° C.) to give a uniform green toner.

### Example 9

### Preparation of Mixed Colour Toners of Different Sizes by Spray-Drying

Toner dispersions prepared according to Preparation Examples E and F were diluted to between 25 and 30% solids and then spray dried using a compact laboratory spray dryer by Drytec, of Tonbridge, Kent, in co-current mode using a 60/100/120 2-fluid (air) atomiser operating between 5 and 7 bar g to give a uniform green toner. Three trial runs were made with variations in the feed dilution, the atomisation air pressure and the outlet temperature. The dry particle size of the products was analysed using a TSI Aerosizer. The operating conditions and results are shown in the following Table.

Further tests below 4 bar atomisation pressure gave poor correlation due to inefficient atomisation.

| Run | Solids | | Feed rate | Outlet temp | Mean size |
|---|---|---|---|---|---|
| number | % | Atomiser Bar | kg/hr | (° C.) | μm |
| 1 | 30 | 5 | 3.12 | 70 | 11.08 |
| 2 | 30 | 7 | 3.67 | 60 | 8.636 |
| 3 | 25 | 7 | 3.68 | 60 | 6.447 |

### Example 10

### Drying of Mixed-Colour Toner with Blocking Agent

A green pigmented toner was produced by mixing 100 grams of each base composition prepared according to Example A and Example B with 2 grams of anti-blocking agent Garamite® 1958, to give a mixture with a pH of 6.9. To this mixture was added 0.1 molar hydrochloric acid under continuous stirring until the mixture had reached a pH of 4.6. The mixture was then filtered and washed three times in de-ionised water and dried to a constant weight in an open tray under vacuum at 35° C. The dried cake broke down during handling into a fine powder with a particle size below around 1 micron, substantially the same as the particles of the base composition.

This product is then agglomerated by known techniques, e.g. mechanical fusion as in Example 1, to give a toner of the invention.

### Preparation of Developer Compositions and Use of Toners

### Example 11

### Modification of Electrostatic Properties

Toner powders produced in the Examples 1 to 6 above were mixed with a carrier powder and agitated to develop the electrostatic tribo charge. On inspection of the particle number charge distribution an assessment was made as to the level and type of charge-control additive needed to adjust this distribution to a condition where in previous tests satisfactory printing was achieved. This procedure will be further described in the following detailed description.

Mixing and Agitation with Carrier

Toner powders from Example 1-6 were mixed with an iron-cored carrier coated with an acrylic polymer and tumbled at a speed of 44 cycles per minute on a turbula T10 mixer for 30 minutes.

A portion of the sample was separated from the carrier and tested using a charge spectrometer capable of resolving the charge/mass ratio of individual toner particles.

### Inspection of the Charge Distributions

The charge/mass data from the charge spectrometer was normalised to show the distribution of charge as a function of the maximum charge attainable on an assumed spherical particle with respect to its mass and assuming that the maximum charge is 0.15000 Femto Coulombs per square micron.

The resulting charge distributions showed that the toners were low-charged, all giving a single peak centred at −0.05 Femto-Coulombs/μm close to the zero axis. This toner separated readily from the carrier due to its low charge and in normal operation would dust from the carrier giving a dust cloud that is undesirable. Furthermore, because the toners had low fluidity, the toners would form loose agglomerates when mixed with the carrier, which is again undesirable for printing.

The required post-agglomeration additive is chosen a) to fluidise the powder to stop the formation of loose agglomerates and b) to generate a significant tribo interaction between the toner and the carrier to charge the toner particles unipolar (typically negative). It is a further requirement of the additive that it modifies the tribo interaction between the carrier and toner particle to “charge-control” the toner such that the charge distribution is a narrow, normal distribution of charges at the required charged level.

### Testing of the Suitability of Particular Post-Agglomeration Additives

### General Method

The charge additive is a combination of a charge-controlling and fluidity-assisting portion comprising aluminium hydroxide and aluminium oxide and also a tribo charge-enhancing portion comprising hydrophobic silica. Typically 2% w/w of the three-component additive is added to charge-control the toner and to confer sufficient fluidity/mobility in the toner for application purposes. The selection of the appropriate additive is made by observation of the charge distribution of the toner. If the toner is lacking in (negative) tribo-charge then more silica is added to increase tribo-charging. If the charge distribution is broad and too highly charged then an additive is chosen that contains less silica and consequently more of the aluminium hydroxide and oxide components.

The required charge distribution of charges is one that is narrow and single-peaked with a mean negative charge at or above 0.1 Femto-Coulombs/μm, preferably above 0.2 Femto-Coulombs/μm. The required charge distributions have been derived from tests using toners that are charged-controlled in the described manner and printed using a Nilpeter DL3300 printing machine. The tests show that the print quality is determined by the electrostatic charge distribution of the toner and that if the charge distribution described above is achieved the toner will give a satisfactory print.

### Tests

An additive comprising 58.5 parts by weight of aluminium hydroxide, 31.5 parts by weight of aluminium oxide and 10 parts by weight of silica (post-extrusion additive formulation 1) was added to toner powders from Examples 1 to 6 in an amount of 2% w/w calculated on the weight before additive added. Each toner was tumbled on an Turbula T10 tumble mixer for 30 minutes at a speed of 44 cycles per minute. The samples were each sieved through a 44 μm sieve. The toners+additive mixtures were each then mixed at a 5% w/w concentration into an iron-core carrier with acrylic polymer coating. The samples were tumbled at 44 cycles per minute on a Turbula T10 mixer and then analysed for their charge distribution by separating from the carrier and measuring the charge by charge spectrometer.

Charge analysis showed that each toner+additive mixture gave a single-peaked charge distribution of negative sign with a charge/diameter value above 0.2 Femto-Coulombs/μm.

### PRINTING EXAMPLES

### Example 12

### Printing with Cyan Toner

To 1000 g of the agglomerated (mechanically-fused) cyan toner base of Example 1, 20 g of an additive comprising 52 parts aluminium hydroxide, 28 parts aluminium oxide and 20 parts silica (Wacker HDK H3004) was added.

The total was tumble-mixed and then sieved through a 44 μm sieve. A reference sample was made by adding 20 g of the above additive to 1000 g of jet-milled cyan toner base of Preparation Example A, which was also tumble-mixed and sieved through a 44 μm sieve. The mobility/fluidity of the mechanically fused toner base was observed to be markedly improved compared to the non-mechanically fused reference toner.

8.5 g of each toner sample was added to 1615 g of an iron-core carrier coated with acrylic to make two different developer mixes. Each developer was tumble-mixed for 30 minutes. Each toner was then printed using a Nilpeter DL3300 printing machine. The prints from the non-agglomerated toner of Preparation Example A were observed to be uneven, with a denser print at the edges of the print. The print from the mechanically fused toner of Example 1 was observed to be very even, with even print density across the whole of the print.

### Example 13

### a) Printing Performance

60 g of post-additive X (45 parts, aluminium hydroxide, 15 parts aluminium oxide, and 40 parts silica (HDK H3004)) (2% w/w) was added and to each 3 kg of the toner of Example 2 and to the comparison powder of Preparation Example B, and each sample was tumble mixed for 30 minutes. After tumbling, each sample was sieved through a 44 μm sieve. 85 g of each toner was then added to 1615 g of a iron core carrier to make two developer samples and both samples were then printed using a Nilpeter DL3300 printing machine. The agglomerated toner sample of Example 2 was replenished with 2.5 kg of agglomerated toner containing the post-additive X (2% w/w) and the non-agglomerated sample of (Preparation Example B) was replenished with 2.5 kg of non-agglomerated toner also containing the post additive X (2% w/w).

The agglomerated toner printed evenly and consistently and the developer showed no signs of charge variation over the time of the print experiment during which 2.5 kg of toner was printed.

During the printing of the non-agglomerated toner, the developer mix showed signs of “dusting” whereby toner that is loosely adhered to the carrier particles is expelled from the developer mixture during printing, causing a dust cloud. This dusting behaviour results in considerable contamination of the print engine and also toner is deposited in the non-printing regions of the printed sheet.

The DL3300 printing machine measures a parameter, the “TC value” during printing to determine the correct addition of replenishing toner to be added to the developer mix. During printing, the machine ensures that this parameter remains constant throughout the print run by the addition of replenishing toner. When the agglomerated toner was used for printing, the TC value was found to be constant throughout the print run. When the non-agglomerated toner was used, the TC value was observed to vary inconsistently and to fall, in time reaching a level at which the machine terminated the print run.

### b) Test of Charge Retention at Different Levels of Silica Additive

### Background

It has been observed in our experiments that the stability of toner charging over a period of time is dependent upon the amount of post-additive added to the toner, more especially the amount of silica added as a post-additive. Charge variation due to high post additive/silica addition is characterised by a fall in the charge over time. This fall in charge is detrimental to print performance and also causes dust clouds of toner to be released from the carrier during printing. These dust clouds comprise low charged toner particles which contaminate the print engine and cannot be controlled for printing. It is a desirable to ensure that the toner does not lose charge after it has been initially mixed with the carrier.

The post-additive has a dual purpose: a) as a charge-control agent and b) as a fluidising agent. The silica component of the post-additive has a very important fluidising effect on the toner. Because the non-agglomerated toner is less fluidisable, it is necessary to add more of the post-additive to this toner compared to the agglomerated toner. This means that the non-agglomerated toner is more prone to lose charge over time than the agglomerated toner.

### Test

Two different samples of cyan toner were prepared. Both samples were made using cyan composition B which had been extruded, milled and agglomerated according to the method previously described in Preparation Example B and Example 2.

For sample 1, additive composition X was added to 10 g of cyan toner of Example 2 to make a 1% w/w concentration of additive. For sample 2, additive composition X was added to 10 g of the cyan toner to make a 2% w/w concentration of additive in the toner. Both samples were tumbled on a turbula T10 mixer for 30 minutes at 44 cycles per minute and each sample was then sieved through a 44 μm sieve. Each sample was then added to 30 g of an iron core carrier coated with a silicone coating to make two developer mixes containing 4% w/w toner and the developer mixes were then tumbled in a container for 60 minutes prior to charge measurement by a charge spectrometer using the technique described in Example 7. Following charge measurement, both developer mixes were tumbled for a further 21 hours then left for 3 days without agitation. Both developer mixes were then tumbled for a further 3 hours and the charge on the toners was re-measured by charge spectrometer.

### Results

| | | | | Charge after 3 |
|---|---|---|---|---|
| | | | Charge after 3 | days rest + 3 hours |
| | Charge after 60 mins | Charge after 21 | days rest no | further tumbling |
| Toner | (μC/g) | hours (μC/g) | tumbling (μC/g) | (μC/g) |
| Sample 1 | −3.52 | −5.41 | −3.72 | −6.64 |
| 1% additive | | | | |
| Sample 2 | −4.00 | −4.61 | −1.72 | −2.41 |
| 2% additive | | | | |

The results show that although both samples lose charge, the 1% sample loses less, and recovers the lost charge after re-tumbling, whereas the 2% sample is unable to recover the lost charge.

### c) Fluidity Enhancement of Agglomerated Toner

The cyan toner composition of Preparation Example B was used to show the enhanced fluidity of this agglomerated toner compared to the non-agglomerated toner.

Two samples were made: sample 1 contained jet-milled toner with particle size d(v,90)=13.0 μm, d(v,50)=8.636 μm and d(v,10)=4.96 μm (Preparation Example B). To 200 g of this toner, 2 g of post-additive X was added. The total was tumble mixed on a Turbula T10 mixer at 44 cycles per minute for 30 minutes. The sample was then sieved through a 44 μm sieve.

Sample 2 contained agglomerated toner (of Example 6) with particle size d(v,90)=14.91 μm, d(v,50)=10.19 μm, d(v,10)=6.36 μm. To 200 g of this toner 2 g of post additive X was added and the sample was treated in exactly the same manner as sample 1.

The fluidity of both samples was determined by Hausner ratio and drop cone angle.

In order to determine the Hausner ratio of a powder, the powder under test is first sieved through a 100-micron mesh sieve and allowed to fall into a cup placed 13 cm below the sieve. The cup is weighed when full of powder (level upper surface of powder mass) to give a value for the weight of the aerated powder.

While tapping the cup 120 times at a rate of 1 tap/second more powder is then added so as to maintain the cup full. The full cup is then weighed again to give a value for the weight of the tapped powder. In our test a Hosokawa powder tester was used.

The Hausner ratio, HR is then given by:

HR=weight of a tapped powder/weight of aerated powder.

The higher the Hausner ratio, the lower the fluidity of the powder.

In order to determine the drop cone angle of a powder, the powder under test is allowed to fall from a sieve and through a funnel placed 7 cm above a circular platform 8 cm in diameter. The process is continued until the cone formed by the falling powder covers the whole surface of the platform. The angle of the cone is then the “drop angle” of the powder. The smaller the cone angle, the greater the fluidity of the powder.

| Sample | Drop cone Angle | Hausner Ratio |
|---|---|---|
| Jet milled sample 1 | 50 degrees | 1.53 |
| Agglomerated sample 2 | 36.7 degrees | 1.38 |

The large drop cone angle and the Hausner ratio above 1.5 indicate that the jet-milled powder has poor fluidity and thus would require more of the post additive X to achieve a fluid condition. The agglomerated toner is able to achieve a satisfactory fluidity with the addition of 1% post additive X.

### Example 14

To a 1500 g sample of jet-milled powder, 30 g of charge-control post additive X as in Example 13 was added and the total tumble-mixed for 60 minutes prior to sieving through a 44 μm mesh sieve. To the agglomerated powder, 30 g of the same additive was added and the sample tumbled and sieved as above. Each toner sample was then made into a developer by mixing 60 g of each toner into 1440 g of a carrier comprising an iron core and an acrylic coating. Both samples were printed using a Nilpeter DL3300 printing machine. Each developer was replenished by its corresponding toner and printing was performed until 1000 g of replenisher had been printed.

The print results showed that although both toners printed, the jet-milled non-agglomerated toner immediately started to dust and contaminated the non printing areas of the paper. The toner separated from the carrier when agitated and contaminated the print machine. In addition the TC parameter was noted to fall to an unacceptable level. The agglomerated toner did not show any signs of dusting and did not separate from the carrier. The print was even and consistent with no contamination of the non printing areas.

1. A process for the preparation of a toner powder, the process comprising combining particles of one or more toner base compositions into larger particles to form the toner powder.

2. A process as claimed in claim 1, wherein the combining is carried out by mechanical fusion to produce composite particles in which individual particles of the one or more toner base compositions are fused or bonded together to form cluster structures that do not break down under the mechanical and electrostatic forces encountered during toner use.

3. A process as claimed in claim 1, wherein the one or more toner base compositions are aqueous emulsions or dispersions.

4. A process as claimed in claim 3, wherein the one or more toner base compositions are prepared by phase inversion emulsification.

5. A process according to claim 4, wherein the phase inversion emulsification is carried out in an extruder.

6. A process as claimed in claim 3, wherein one of the one or more base compositions is a dispersion or emulsion having a mean particle size below 5 μm.

7. A process as claimed in claim 3, wherein combining of the particles of the one or more toner base compositions is carried out by spray-drying a liquid base composition to form a fused agglomerate comprising single particles.

8. A process as claimed in claim 3, wherein the one or more toner base compositions are freeze-dried and subsequently agglomerated by mechanical fusion to produce composite particles in which individual particles of the toner base composition are fused or bonded together to form cluster structures that do not break down under the mechanical and electrostatic forces encountered during toner use.

9. A process as claimed in claim 1, wherein particles of two or more differently coloured toner base compositions are combined.

10. A process as claimed in claim 1, wherein the toner powder has a d(v,90)<15 μm.

11. A process as claimed in claim 1, wherein the larger particles are mixed with a fluidity-enhancing and charge-modifying particulate post-additive.

12. A toner powder comprising composite particles comprising individual particles of at least one toner base composition which are fused or bonded together in the form of cluster structures that do not break down under the mechanical and electrostatic forces encountered during toner use.

13. A toner powder as claimed in claim 12, wherein the individual particles are of different colour.

14. A toner powder comprising composite particles comprising individual particles of at least one toner base composition which are fused or bonded together to form single substantially spherical particles.

15. A toner powder as claimed in claim 12, wherein the individual particles have a d(v,90)<15 μm.

16. A toner powder as claimed in claim 12 further comprising particles of a fluidity-enhancing and charge-modifying additive mixed with but not part of the composite particles.

17. A developer composition comprising a toner powder as claimed in claim 12, in admixture with carrier particles.

18. (canceled)

19. A process for electrographic copying comprising copying electrographically with the toner powder as claimed in claim 12.

20. (canceled)

21. A process for electrographic printing comprising printing electrographically with the toner powder as claimed in claim 12.

22. A process for electrographic copying comprising copying electrographically with the developer composition as claimed in claim 17.
